(19) United States
(12) Patent Application Publication
(10) Pub. No.: US 2005/0275905 A1
(43) Pub. Date: Dec. 15, 2005

(54) Image acquiring device capable of rotating a document image

(75) Inventor: Wei-Pang Huang, Taipei City (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/147,369

(22) Filed: Jun. 8, 2005

(30) Foreign Application Priority Data
Jun. 11, 2004 (TW) 093116786

(51) Int. Cl. H04N 1/04

(52) U.S. Cl. 358/474

(57) ABSTRACT

In an image acquiring device capable of rotating a document image, a scanning module cooperates with a driving mechanism to scan a document and generate an analog image signal accordingly. A rotation-setting unit is actuated for outputting a rotation signal for rotating the analog image signal by 180 degrees, or a normal signal for not rotating the analog image signal by 180 degrees. A control/processing unit processes the analog image signal into a normal digital image signal according to the normal signal, or processes and rotates the analog image signal by 180 degrees according to the rotation signal to generate a rotated digital image signal.

### BACKGROUND OF THE INVENTION

1. Field of the Invention

The invention relates to an image acquiring device capable of rotating a document image, and more particularly to an image acquiring device having a rotation-setting unit configured such that a user can choose whether to rotate the document image or not.

2. Description of the Related Art

In the prior art, a document image acquired by a scanner is being rotated with the aid of computer application software, such that users may determine whether the document image has to be rotated according to the visible result of the document image. Or a specific OCR (Optical Character Recognition) software has to be utilized to determine the rotation angle of the document image.

However, more and more scanners are designed as being independent of a computer or host, i.e., these scanners need not be connected to the computer for them to work. For example, some scanners may be directly connected to a printer and directly process the scan results into printing signals that can be accepted by the printer. Alternatively, some scanners can be directly connected to the Internet or FAX network, and the scan results are directly processed into digital signals that can be transmitted over the Internet or FAX network. However, the orientations of some sheets of a bound document being placed on the scanning platen, or those of some of a stack of documents being fed by an automatic document feeder may be different from those of others. In this case, it is inconvenient to manually rotate the document images by using the computer application software. If the OCR method is adopted to the document images of a stack of the documents, a relatively large memory is required and the document images containing only pictures cannot be correctly recognized and be rotated into the same orientation.

More particularly, when documents is bound together into, for example, a book, the document images of the even-numbered pages appear inverted to those of the odd-numbered pages in orientations for the binding section of the book has to be leaning on a positioning edge for each page to be scanned. Thus, the document images of the even-numbered pages have to be rotated by 180 degrees, and it is inconvenient to use the conventional processing method.

Therefore, it is an important object of the invention to provide an image acquiring device enabling the user to set the orientation of the document image directly.

### SUMMARY OF THE INVENTION

It is therefore an object of the invention to provide an image acquiring device capable of rotating a document image, wherein the orientation of the document image may be easily set by a user through a hardware switch.

To achieve the above-mentioned object, the invention provides an image acquiring device including a scanning module, a driving mechanism, a rotation-setting unit and a control/processing unit. The scanning module scans a document and generates an analog image signal accordingly. The driving mechanism moves either one of the scanning module and the document. The rotation-setting unit is actuated for outputting a rotation signal for rotating the analog image signal by 180 degrees, or a normal signal for not rotating the analog image signal by 180 degrees. The control/processing unit controls operations of the scanning module and the driving mechanism, and processes the analog image signal into a normal digital image signal according to the normal signal or processes and rotates the analog image signal by 180 degrees to generate a rotated digital image signal according to the rotation signal.

The invention also provides an image acquiring device to be electrically connected to an image processing device. The image acquiring device includes a scanning module, a driving mechanism, a rotation-setting unit, a control/processing unit and an input/output port. The scanning module scans a document and generates an analog image signal accordingly. The driving mechanism moves either one of the scanning module and the document. The rotation-setting unit is actuated for outputting a rotation signal for rotating the analog image signal by 180 degrees, or outputting a normal signal for not rotating the analog image signal by 180 degrees. The control/processing unit controls operations of the scanning module and the driving mechanism, receives the normal signal or the rotation signal, and processes the analog image signal into a digital image output signal. The input/output port, which is connected to the control/processing unit, outputs the digital image output signal and the normal signal, or the digital image output signal and the rotation signal to the image processing device, such that the image processing device rotates or does not rotate the digital image output signal according to the rotation signal or the normal signal.

Consequently, it is convenient for the user to set the rotation state of the digital image, and to shorten the time for the subsequent processing procedures.

### BRIEF DESCRIPTION OF THE DRAWINGS

FIG. 1 is a block diagram showing an image acquiring device according to a first embodiment of the invention.

FIG. 2 is a block diagram showing an image acquiring device according to a second embodiment of the invention.

FIGS. 3 and 4 show two states of an example using the image acquiring device of the invention to scan a book.

FIGS. 5 and 6 show two states of another example using the image acquiring device of the invention to scan a book.

### DETAILED DESCRIPTION OF THE INVENTION

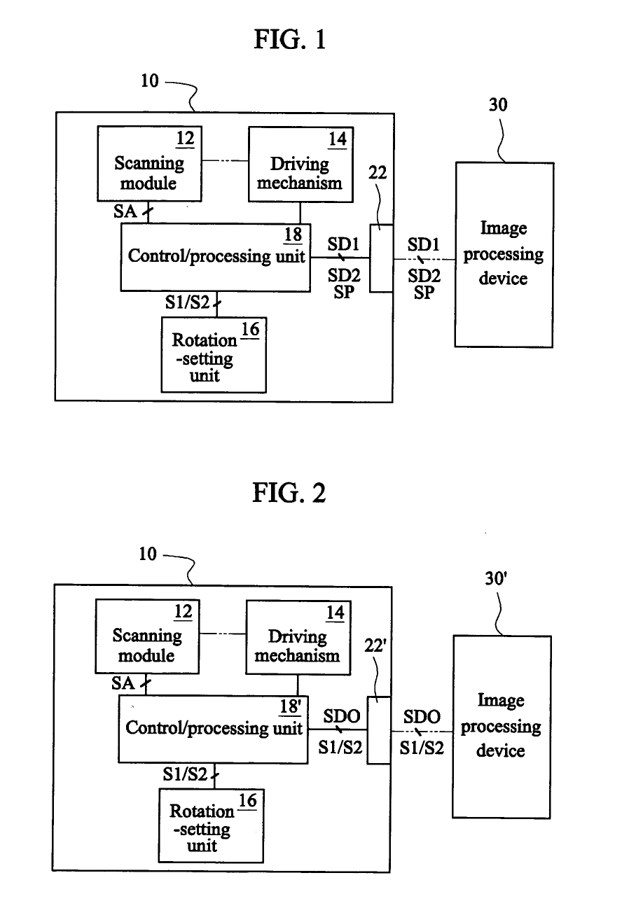

FIG. 1 is a block diagram showing an image acquiring device according to a first embodiment of the invention. Referring to FIG. 1, an image acquiring device 10 of this embodiment includes a scanning module 12, a driving mechanism 14, a rotation-setting unit 16, a control/processing unit 18 and an input/output port 22. The control/processing unit 18 includes a memory for memorizing data or serving as a buffer. The scanning module 12 scans a document and generates an analog image signal SA. The image acquiring device 10 may be a flatbed scanning device or a sheet-fed scanning device, so the driving mechanism 14 can move either one of the scanning module 12 and the document. The rotation-setting unit 16 is actuated for outputting a rotation signal S1 for rotating the analog image signal SA by 180 degrees, or outputting a normal signal S2 for not rotating the analog image signal SA by 180 degrees. The control/processing unit 18 controls operations of the scanning module 12 and the driving mechanism 14, and processes the analog image signal SA into a normal digital image signal SD1 according to the normal signal S2, or processes and rotates the analog image signal SA by 180 degrees to generate a rotated digital image signal SD2 according to the rotation signal S1. The rotated digital image signal SD2 or the normal digital image signal SD1 may be outputted to an image processing device 30, such as a computer system, through the input/output port 22, and the image processing device 30 can further process the signals SD1 or SD2. The computer system may include a network system or a FAX system.

Alternatively, the control/processing unit 18 may further process the rotated digital image signal SD2 or the normal digital image signal SD1 into a printing signal SP. The printing signal SP is outputted to the image processing device 30, such as a printing device for printing data, through the input/output port 22. Alternatively, the printing device may be directly contained in the image acquiring device 10 such that the image acquiring device 10 has a copy function.

FIG. 2 is a block diagram showing an image acquiring device according to a second embodiment of the invention. As shown in FIG. 2, the image acquiring device 10 of this embodiment is connected to an image processing device 30′. The image acquiring device 10 includes a scanning module 12, a driving mechanism 14, a rotation-setting unit 16, a control/processing unit 18′ and an input/output port 22′. This embodiment is similar to the first embodiment except for the processing function, the output signal of the control/processing unit 18′ and the signal outputted from the input/output port 22′.

Specifically speaking, the control/processing unit 18′ of this embodiment controls the operations of the scanning module 12 and the driving mechanism 14, receives the normal signal S2 or the rotation signal S1, and processes the analog image signal SA into a digital image output signal SDO. The input/output port 22′ connected to the control/processing unit 18′ outputs the digital image output signal SDO and the normal signal S2 or the rotation signal S1 to the image processing device 30′, such that the image processing device 30′ rotates or does not rotate the digital image output signal SDO according to the rotation signal S1 or the normal signal S2.

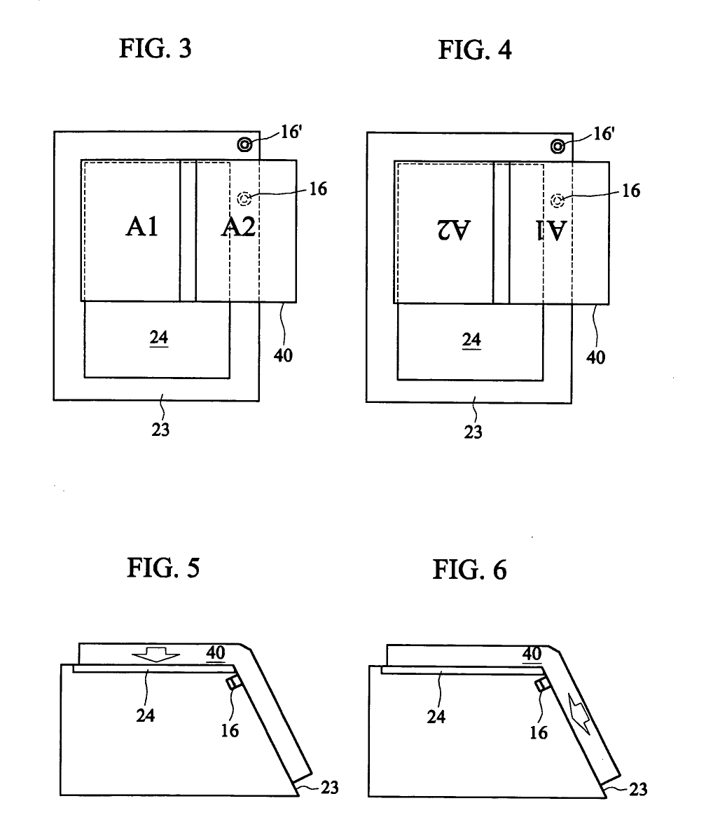

FIGS. 3 and 4 show two states of an example using the image acquiring device of the invention to scan a book. As shown in FIGS. 3 and 4, the image acquiring device 10 further includes a housing 23 and a transparent platen 24. The rotation-setting unit 16 is mounted on the housing 23. The transparent platen 24 for supporting a document is connected to the housing 23. The book 40 placed on the transparent platen 24 actuates the rotation-setting unit 16 to output the rotation signal S1 or the normal signal S2. In this embodiment, the book 40, which is an open bound document, is substantially spread out by 180 degrees and placed on the image acquiring device 10. In another embodiment, the book may be replaced with a document consisting of a plurality of sheets. Alternatively, the user may actuate the rotation-setting unit 16′ to output the rotation signal or the normal signal. In practice, only one of the rotation-setting units 16 and 16′ is needed.

FIGS. 5 and 6 show two states of another example using the image acquiring device of the invention to scan a book. In this example, the image acquiring device 10 is a book scanner, where the book 40 may be an open bound document substantially spread out by an angle smaller than 180 degrees and placed on the image acquiring device 10.

In order to facilitate the scanning processes of the bound documents, i.e., the book, the rotation-setting unit may be actuated by the user into a bound document scan mode, in which the rotation-setting unit outputs the rotation signal and the normal signal alternately for the sheets. In this case, the rotation-setting unit outputs the normal signal prior to the rotation signal such that the images of all the even-numbered pages (or odd-numbered pages) are rotated, while the images of all the odd-numbered pages (or even-numbered pages) are not rotated. Alternatively, if the user does not want to rotate the image of one of the even-numbered pages (or odd-numbered pages), he or she can actuate the rotation-setting unit before this page is scanned such that the rotation-setting unit outputs the normal signal, and the image of this page will not be rotated. Alternatively, if the user wants to rotate the image of one of the odd-numbered pages (or even-numbered pages), he or she can actuate the rotation-setting unit before this page is scanned such that the rotation-setting unit outputs the rotation signal, and the image of this page will be rotated. Thus, the rotation-setting unit may include multiple buttons for the user to set the bound document scan mode and to have various scan options.

According to the above-mentioned device of the invention, the user can easily set the orientation state of the document images, and it is more convenient for the user to scan documents which are bound together. Furthermore, the operation procedure for rotating document images is simplified by the rotation-setting unit which can be activated simply by a book, even without complicated software programming. Only one rotation-setting unit for outputting different signals has to be added in order to rotate the image. The image acquiring device itself or the image processing device can rotate the image when the next page of image is scanned, and the overall processing time may be shortened.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. An image acquiring device, comprising:
a scanning module for scanning a document and generating an analog image signal accordingly;
a driving mechanism for moving either one of the scanning module and the document;
a rotation-setting unit actuated for outputting a rotation signal for rotating the analog image signal by 180 degrees, or outputting a normal signal for not rotating the analog image signal by 180 degrees; and
a control/processing unit for controlling operations of the scanning module and the driving mechanism, and processing the analog image signal into a normal digital image signal according to the normal signal or processing and rotating the analog image signal by 180 degrees to generate a rotated digital image signal according to the rotation signal.

2. The device according to claim 1, wherein the rotated digital image signal or the normal digital image signal is outputted to a computer system through an input/output port.

3. The device according to claim 1, wherein the control/processing unit further processes the rotated digital image signal or the normal digital image signal into a printing signal, which is outputted to a printing device through an input/output port.

4. The device according to claim 1, wherein the rotation-setting unit is actuated directly by a user to output the rotation signal or the normal signal.

5. The device according to claim 1, further comprising:
a housing, on which the rotation-setting unit is mounted; and
a transparent platen, connected to the housing, for supporting the document, wherein the document placed on the transparent platen actuates the rotation-setting unit to output the rotation signal or the normal signal.

6. The device according to claim 5, wherein the document is an open bound document.

7. The device according to claim 1, wherein the document consists of a plurality of sheets.

8. The device according to claim 7, wherein the rotation-setting unit outputs the rotation signal and the normal signal alternately for the sheets.

9. The device according to claim 8, wherein the rotation-setting unit outputs the rotation signal prior to the normal signal.

10. The device according to claim 8, wherein the rotation-setting unit outputs the normal signal prior to the rotation signal.

11. An image acquiring device to be electrically connected to an image processing device, the image acquiring device comprising:
a scanning module for scanning a document and generating an analog image signal accordingly;
a driving mechanism for moving either one of the scanning module and the document;
a rotation-setting unit actuated for outputting a rotation signal for rotating the analog image signal by 180 degrees, or outputting a normal signal for not rotating the analog image signal by 180 degrees;
a control/processing unit for controlling operations of the scanning module and the driving mechanism, receiving the normal signal or the rotation signal, and processing the analog image signal into a digital image output signal; and
an input/output port, which is connected to the control/processing unit, for outputting the digital image output signal and the normal signal, or the digital image output signal and the rotation signal to the image processing device, such that the image processing device rotates or does not rotate the digital image output signal according to the rotation signal or the normal signal.

12. The device according to claim 11, wherein the rotation-setting unit is actuated directly by a user to output the rotation signal or the normal signal.

13. The device according to claim 11, further comprising:
a housing, on which the rotation-setting unit is mounted; and
a transparent platen, connected to the housing, for supporting the document, wherein the document placed on the transparent platen actuates the rotation-setting unit to output the rotation signal or the normal signal.

14. The device according to claim 13, wherein the document is an open bound document.

15. The device according to claim 11, wherein the document consists of a plurality of sheets.

16. The device according to claim 15, wherein the rotation-setting unit outputs the rotation signal and the normal signal alternately for the sheets.

17. The device according to claim 16, wherein the rotation-setting unit outputs the rotation signal prior to the normal signal.

18. The device according to claim 16, wherein the rotation-setting unit outputs the normal signal prior to the rotation signal.
